(19) United States
(12) Patent Application Publication
(10) Pub. No.: US 2003/0172528 A1
(43) Pub. Date: Sep. 18, 2003

(54) Method of cable integration

(76) Inventors: Ta-Wei Huang, Tu-Chen (TW); Shao-Feng Zhang, Kunshan (CN); Yun-Jin Jiang, Kunshan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/286,049

(22) Filed: Nov. 1, 2002

(30) Foreign Application Priority Data
Mar. 13, 2002 (TW) 91104672

(51) Int. Cl. H01R 43/00

(52) U.S. Cl. 29/868; 29/857; 29/876

(57) ABSTRACT

A method of integrating a plurality of cables (12) used for interconnecting electrical devices. In a preferred embodiment, firstly, a precursor cable is prepared and cut into a plurality of cables as required for a particular application. Secondly, the cables are put into a sleeve (14). First ends (16) and opposite second ends (18) of the cables protrude out suitable predetermined distances from opposite ends of the sleeve respectively. Thirdly, the cables are fixed in the sleeve. Finally, the first and second ends are precision cut as required for the particular application, and respectively joined to corresponding connectors as required for the particular application. A cable module (10) is thus formed. An alternative embodiment of the method is also disclosed.

### BACKGROUND OF THE INVENTION

1. Field of the Invention

The present invention relates to a method for integrating a plurality of cables, and particularly to a method for integrating a plurality of electrical cables used for interconnecting two electrical devices.

2. Description of Prior Art

As the development and innovations of electrical technology continue to advance, electrical devices are being designed to have an increasing number of improved functions. New electrical products are developed and marketed in rapid succession. Accordingly, interconnection and information transmission among various electrical products are constantly being developed, particularly for multifunction electrical transmission systems.

Cables are generally adopted to electrically connect electrical devices. A conventional means for assembling a plurality of cables is to respectively fix electrical connectors to first and second ends of the cables. The electrical connectors of the first ends of the cables can respectively mate with corresponding electrical connectors of a first electrical device, and the electrical connectors of the second ends of the cables can respectively mate with corresponding electrical connectors of a second electrical device. The cables thus interconnect the first and second electrical devices.

Conventional cables are often directly exposed to the environment, and are subject to degradation and accidental damage. Multiple cable systems are prone to twisting and misconnection.

New means for integration of a plurality of cables which can overcome the shortcomings of conventional cable technology are desired.

### SUMMARY OF THE INVENTION

In view of the above, an object of the present invention is to provide a method of integrating a plurality of cables that yields excellent connection among electrical devices.

Another object of the present invention is to provide a simple manufacturing procedure for a cable module.

A further object of the present invention is to provide a manufacturing procedure for a cable module which insures manufacturing precision, saves manpower and reduces manufacturing costs.

A still further object of the present invention is to provide a method of integrating a plurality of cables which effectively protects the cables.

To fulfill the above-mentioned objects, a method of integrating a plurality of cables used for interconnecting electrical devices is provided by the present invention. In a preferred embodiment of the method, firstly, a precursor cable is prepared and cut into a plurality of cables as required for a particular application. Secondly, the cables are put into a sleeve. First ends and opposite second ends of the cables protrude out suitable predetermined distances from opposite ends of the sleeve respectively. Thirdly, the cables are fixed in the sleeve. Finally, the first and second ends are precision cut as required for the particular application, and respectively joined to corresponding connectors as required for the particular application. A cable module is thus formed.

In an alternative embodiment of the method, firstly, a precursor cable is prepared and cut into a plurality of cables as required for a particular application. Secondly, first ends of the cables are cut as required for the particular application, and joined to corresponding connectors as required for the particular application. Thirdly, the cables are extended through the sleeve, second ends first. Fourthly, the cables are fixed in the sleeve. Finally, the second ends of the cables are precision cut as required for the particular application, and joined to corresponding connectors as required for the particular application. A cable module is thus formed.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a cable module constructed in accordance with a preferred embodiment of the method of the present invention, and showing the cable module interconnecting two electrical devices;

FIG. 2 is an enlarged schematic side plan view of the cable module of FIG. 1 partly constructed in accordance with the preferred embodiment of the method of the present invention, and showing two cables of the cable module;

FIG. 3 is similar to FIG. 2, but showing the cable module fully constructed;

FIG. 4 is a side plan view of one cable for a cable module, and showing the cable partly constructed in accordance with an alternative embodiment of the method of the present invention;

FIG. 5 is a schematic side plan view of the cable module referred to in relation to FIG. 4 above, and showing the cable module including two cables thereof partly constructed in accordance with the alternative embodiment of the method of the present invention; and

FIG. 6 is similar to FIG. 5, but showing the cable module fully constructed.

### DETAILED DESCRIPTION OF PREFERRED EMBODIMENTS OF THE INVENTION

Reference will now be made to the drawings to describe the present invention in detail.

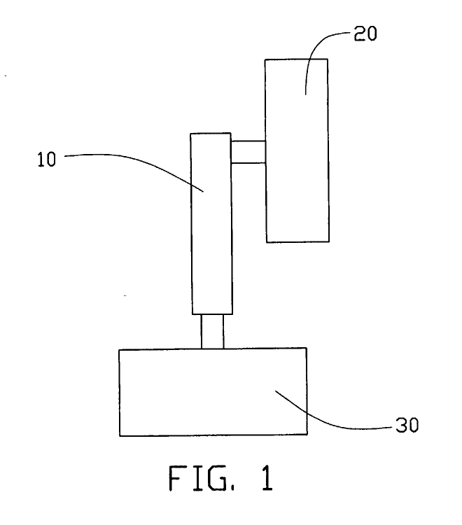

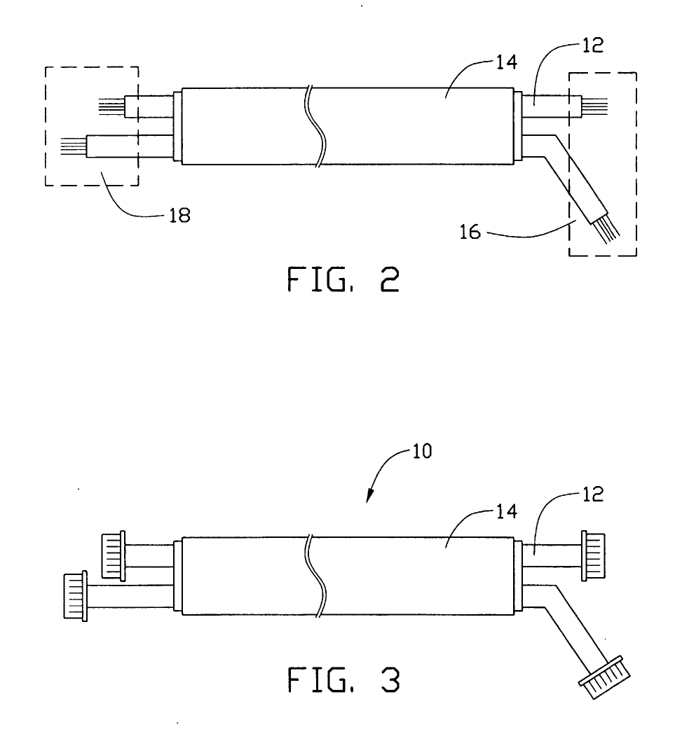

Referring to FIGS. 1 and 2, a cable module 10 comprises a plurality of cables 12 (only a pair of cables 12 is shown) used to respectively transmit electrical signals, and a rigid sleeve 14. The cables 12 extend through the sleeve 14, and opposite ends of each cable 12 are respectively electrically connected to a first electrical device 20 and a second electrical device 30. Thus an electrical transmission system is formed, wherein signal transmission between the first and the second electrical devices 20, 30 can be obtained.

Because the sleeve 14 is rigid, it can provide support for holding the first electrical device 20. Furthermore, the sleeve 14 holds the cables 12 therein and protects them.

The present invention relates to a method for assembling the cables 12 into the sleeve 14, and related procedures. FIGS. 2 and 3 illustrate a preferred embodiment of the method of the present invention.

Firstly, a precursor cable is prepared and cut into a plurality of cables 12 (only a pair of cables 12 is shown) as required for a particular application. Secondly, the cables 12 are put into the sleeve 14. First ends 16 and opposite second ends 18 of the cables 12 protrude out suitable predetermined distances from opposite ends of the sleeve 14 respectively. Thirdly, the cables 12 are fixed in the sleeve 14. Finally, the first and second ends 16, 18 are precision cut as required for the particular application, and respectively joined to corresponding connectors (not labeled) as required for the particular application. The cable module 10 is thus formed (see FIG. 3).

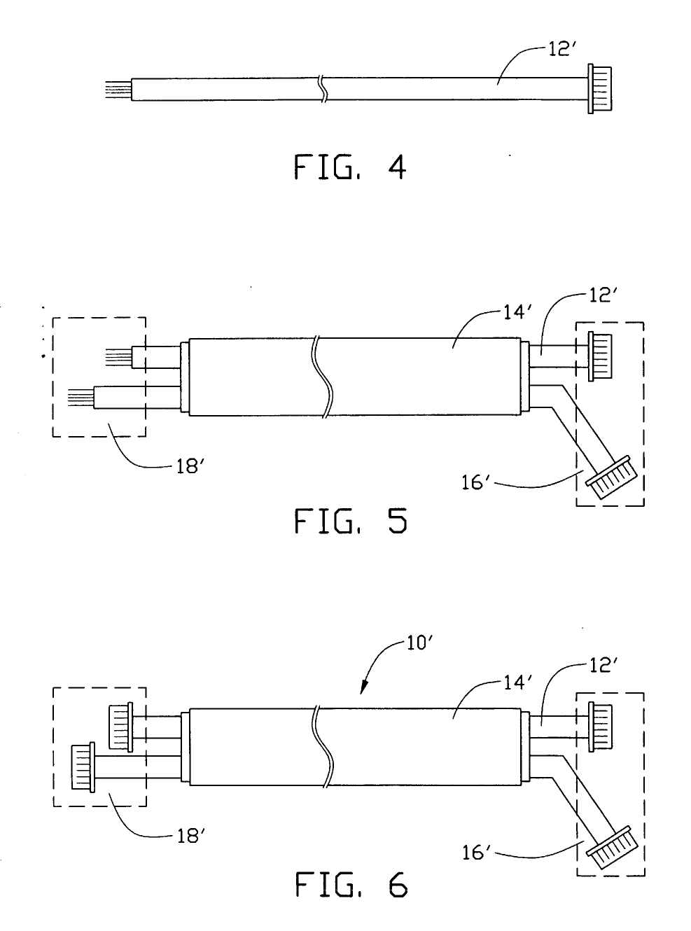

FIGS. 4, 5 and 6 illustrate an alternative embodiment of the method of the present invention. Firstly, a precursor cable is prepared and cut into a plurality of cables 12′ (only a pair of cables 12′ is shown) as required for a particular application. Secondly, first ends 16′ of the cables 12′ are cut as required for the particular application, and joined to corresponding connectors (not labeled) as required for the particular application. Thirdly, the cables 12′ are extended through the sleeve 14′, second ends 18′ first. Fourthly, the cables 12′ are fixed in the sleeve 14′. Finally, the second ends 18′ of the cables 12′ are precision cut as required for the particular application, and joined to corresponding connectors (not labeled) as required for the particular application. A cable module 10′ is thus formed (see FIG. 6).

The alternative embodiment has even more advantages than the preferred embodiment. In the alternative embodiment, the first ends 16′ of the cables 12′ are cut as required for the particular application, and joined to the corresponding connectors (not labeled) as required for the particular application. The first ends 16′ do not need to be precision cut, because the cables 12′ are subsequently extended through the sleeve 14′. Thereafter, the first ends 16′ need only be suitably positioned relative to a proximate end of the sleeve 14′ to ensure that the first ends 16′ comply with the requirements of the particular application.

While preferred embodiments in accordance with the present invention have been shown and described, equivalent modifications and changes known to persons skilled in the art according to the spirit of the present invention are considered within the scope of the present invention as defined in the appended claims.

What is claimed is:

1. A method of integrating a plurality of cables used for interconnecting electrical devices, the method comprising the steps of:
providing a plurality of cables;
providing a rigid sleeve, putting the cables into the sleeve such that opposite ends of the cables protrude out from opposite ends of the sleeve, and fixing the cables in the sleeve; and
cutting the opposite ends of the cables, and respectively joining the opposite ends to a plurality of connectors.

2. The method as claimed in claim 1, wherein the cables are cut from a precursor cable.

3. The method as claimed in claim 1, wherein the sleeve can provide support for holding at least one of the electrical devices.

4. A method of integrating a plurality of cables used for interconnecting electrical devices, the method comprising the steps of:
providing a plurality of cables having first ends and opposite second ends;
cutting the first ends of the cables, and respectively joining the first ends to a plurality of connectors;
providing a rigid sleeve, extending the cables through the sleeve second ends first such that the first and second ends of the cables protrude out from opposite ends of the sleeve, and fixing the cables in the sleeve; and
cutting the second ends of the cables, and respectively joining the second ends to a plurality of connectors.

5. The method as claimed in claim 4, wherein the cables are cut from a precursor cable.

6. The method as claimed in claim 4, wherein the sleeve can provide support for holding at least one of the electrical devices.

7. A method of making a cable assembly comprising steps of:
providing a plurality of discrete cable units;
providing a sleeve with a designed length thereof;
cutting said cable units with other designed lengths, respectively, in compliance with said first designed length, and defining two corresponding opposite connection ends thereof;
keeping the connection ends on the common side of said cable units free and inserting said connection ends into one end of the sleeve, having said connection ends move along said sleeve, and finally exposed to an exterior on the other end of the sleeve; and
terminating said connection ends of the cable units with either one common connector or plural respective connectors.

8. The method as claimed in claim 7, wherein other connection ends of said cable units are assembled to a common connector or plural respective connectors either before said connection ends of said cable units pass the sleeve or after.
